(19) United States
(12) Patent Application Publication
(10) Pub. No.: US 2006/0045107 A1
(43) Pub. Date: Mar. 2, 2006

(54) Network solution for integrated control of electronic devices between different sites

(76) Inventors: Ray Kucenas, Corona, CA (US); Roger Barker, Aliso Viejo, CA (US)

Correspondence Address: STETINA BRUNDA GARRED & BRUCKER, 75 ENTERPRISE, SUITE 250, ALISO VIEJO, CA, 92656, US

(21) Appl. No.: 11/208,837

(22) Filed: Aug. 22, 2005

Related U.S. Application Data
(60) Provisional application No. 60/604,317, filed on Aug. 25, 2004.

(51) Int. Cl. H04B 7/00

(52) U.S. Cl. 370/401; 370/310

(57) ABSTRACT

A network solution for integrated control of electronic devices between different sites is provided to enable complete control of home electronic devices, automotive devices, watercraft devices and aircraft electronic device with an affordable cost to the general public. The network solution has a hardware solution and a software solution integrated with each other. The hardware has a main server located at a first site to link with and control various electronic devices located at the first site, and a computer located at a second site to link with and control various electronic devices at the second site. The software provides a user interface program for interfacing the main server and the computer with the electronic devices linked therewith, respectively, and an internetworking model interacting with the user interface program to communicate the main server and the computer. Therefore, the user is able to control the electronic devices at a distant site.

### CROSS-REFERENCE TO RELATED APPLICATIONS

This application claims priority to Provisional Patent Application Ser. No. 60/604,317, filed Aug. 25, 2004, entitled NETWORK SOLUTION FOR INTEGRATED CONTROL OF ELECTRONIC DEVICES BETWEEN DIFFERENT SITES, the disclosure of which is expressly incorporated herein by reference.

### STATEMENT RE: FEDERALLY SPONSORED RESEARCH/DEVELOPMENT

Not Applicable

### BACKGROUND

The present invention relates in general to an electronic network solution, and more particularly, to an integrated control of electronic devices between different sites.

There is always a need for high technology devices that help make life easier. Recently, various wire or wireless communications have been used for integrating control of limited home electronics. However, the devices that implement the integration of control are very costly and therefore typically unaffordable for the general public. Currently, most devices that implement the integration of control are limited to access of electronic devices within a specific site. It is not unusual that a consumer will suddenly realize that the air conditioner, oven or other home appliance has remained on when he or she is driving in a vehicle. The consumer will therafter have to drive all the way back to turn off the home appliance. This causes great inconvenience in the daily lives of general consumers.

Thus a substantial need in the art to provide a network solution for integrated control of electronic devices between different sites, such that many of the electronic devices or appliances can be used and operated more safely and conveniently for consumers.

### BRIEF SUMMARY

A network solution for integrated control of electronic devices between different sites is provided to enable complete control of home electronic devices, automotive devices, watercraft devices and aircraft electronic devices with an affordable cost to the general public. The network solution includes a hardware solution and a software solution integrated with each other. The hardware includes a main server located at a first site to link with and control various electronic devices located at the first site, and a computer located at a second site to link with and control various electronic devices at the second site. The software includes a user interface program for interfacing the main server and the computer with the electronic devices linked therewith, and an internetworking model interacting with the user interface program to communicate the main server and the computer. Therefore, the user is able to control the electronic devices at a distant i.e. remote site.

In one embodiment, an Open System Interconnect model is selected to interact with the user interface program. The Open system Interconnect model includes an Application layer, a Presentation layer, a Session layer, a Transport layer, a Network layer, a Data link layer and a Physical layer, and the user interface program includes a customer layer directly interacting with the Application layer. Preferably, all the electronic devices linked with the main server and the computer are integrated to interface with the same user interface program loaded to the main server and the computer, respectively. Additionally, all the electronic devices linked with the main server can also interface with the user interface program loaded in the computer via the user interface program loaded in the main server. Thereby, the integrated control of electronic devices at different sites can be realized. In each of the first and second sites, a user interface such as a touch screen is also provided thereby allowing the user to selectively control electronic devices.

For security concern, the computer at the second site and/or the main server at the first site may also be linked with a biometric device for identifying the user. The software is preferably a conventional Flash based program, such that modification or customization can be easily performed and stored. The user interface program may be designed with various user-friendly texts, icons or pictures in various colors and background, such that an easier access can be provided to each individual user.

### BRIEF DESCRIPTION OF THE DRAWINGS

These and other features and advantages of the various embodiments disclosed herein will be better understood with respect to the following description and drawings, in which like numbers refer to like components, structures, elements and/or steps throughout, and in which:

FIG. 1 illustrates a home integration and automation system;

FIG. 2 illustrates a mobile integration and automation system; and

FIG. 3 illustrates the user interface of the integrated hardware/software system.

### DETAILED DESCRIPTION

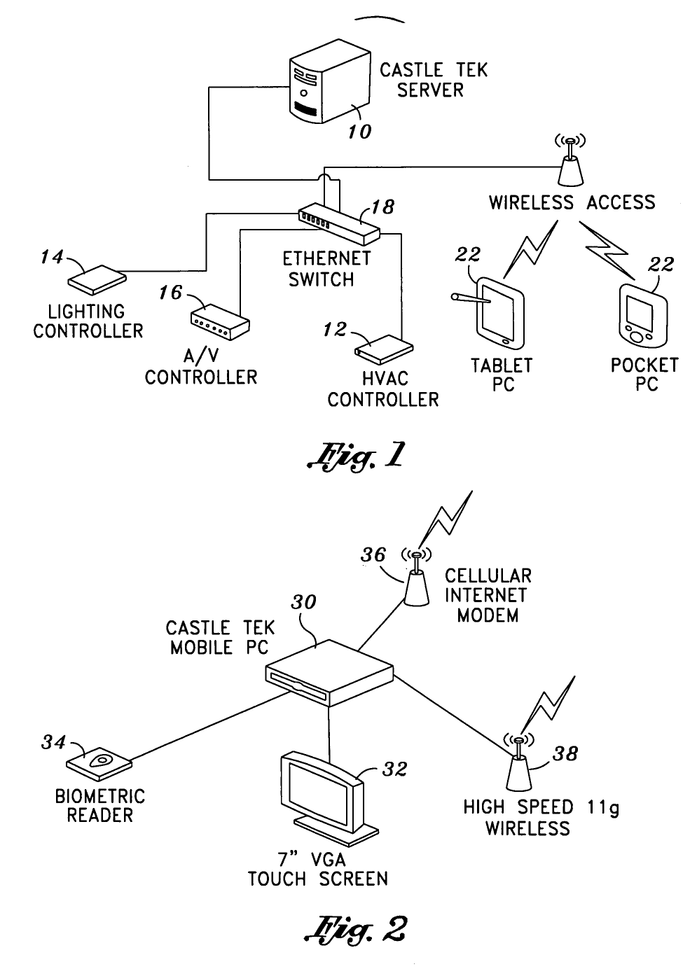

The network solution as provided in the present invention enables complete integrated control of home electronic devices, automotive devices, watercraft devices and aircraft electronic devices and the like at various different sites. The devices controllable by the integrated hardware/software solution include, but are not limited to entertainment systems, computer systems, temperature control systems, security systems and environment control systems. The network solution includes a hardware solution integrated with a software solution. FIG. 1 illustrates an exemplary home hardware solution for controlling of various types of home electronic devices. As shown, the home hardware solution includes a main server computer 10 such as a personal computer or a Macintosh computer that has sufficient processing speed and memory to handle the needs of the custom systems. In the preferred embodiment, an off-the-shelf Pentium processor with 512 MB to 1 GB RAM and 60 GB to 120 GB hard disk is used. The main server computer 10 includes a multi-port serial hub to link to a variety of devices.

The devices commonly linked to and controlled by the main server computer 10 include, but are note limited to, lights, temperature controls, sprinklers, spas, pools, network hubs, appliances, ovens, internet wireless devices, entertainment systems with multiple televisions and zones, home security with numerous cameras and other developing technologies. In the present disclosed embodiment, a temperature control device 12, a light control device 14, a camera system 16, a door locking system (not shown), a drape/shade control system (not shown), and a plurality of mini personal computers 22 are linked to the main server computer 10.

The temperature control device 12 includes a serial adapter that interfaces with the main server 10 and a controller box that interfaces between the serial adapter and a thermostat to provide manual access for changing home or environmental temperature. The light control device 14 includes a serial adapter that interfaces with the main server 10, a wireless repeater, and a light control that is wirelessly or manually controlled. Examples of the temperature control device and the light control device include a conventional Honeywell HVAC control package and Lutron light control device, respectively. The camera system 16 is preferably coupled to the Internet directly via a cable connection such as a conventional CAT5 Ethernet Connection 18. The camera system 16 may include multiple cameras integrated into the main server 10, such that security on various locations such as the doors, yards, garages or other locations around the home can be monitored. The door locking system includes a serial adapter to interface with the main server 10 and a locking mechanism mounted on the lock in the receiving side of a conventional lock tongue mechanism. The locking mechanism can thus be remotely controlled through the main server 10. The drape/shade control system includes a serial adapter to interface with the main server 10 through the hub and an actuator motor box that pulls the cords to open and close the window drapes or shades. Conventional mini personal computers 22 are mounted on the walls of various rooms or wirelessly linked to the main server 10, such that the user can operate the mini personal computers 22 everywhere in the home. For example, the mini personal computers 22 may be installed in the rooms where the user intends to separate DVD playback or MP3 music stored in the main server 10. Preferably, each of the mini personal computers 22 comprise a touch screen allowing control of the entire system as illustrated in FIG. 3.

It will be appreciated that, in addition to the devices as described above, the home hardware solution can be used to control devices implemented in any mechanism or device that can be connected with a serial interface, USB, Firewire 1394, parallel port or any other conventional devices to interface with a computer.

To control the devices as described above, a software solution is integrated with the hardware solution. In one embodiment, Microsoft Windows XP Pro is used as the operating system (OS) for the integration system because many of the drivers for the existing electronic devices have already been loaded into such operating system. Each electronic device typically has a software driver that is either provided by the manufacture or is specifically developed. A software or user interface program is loaded to interface with the device drivers and the operating system, such that various tasks can be performed, and commands can be sent via the Internet, 802.11 or direct wiring.

To allow the user to change texts or graphs that help describe the functions of the devices controlled by the integrated system, the user interface program is preferably customizable and Flash based, such that it is easy to modify and reprogram. The user controls all the devices linked to the computer by the touch screens that all have the easy-to-understand menus and controls. The user interface program is operative to interact with the standard open Internet (OSI) model, of which the functions are implemented by a protocol. The OSI model is a conceptual model composed of seven layers, including Layers 1 to 7, namely, Physical layer, Data link layer, Network layer, Transport layer, Session layer, Presentation layer, and Application layer, each specifying particular network functions. In application, the Application layer, the Presentation layer, and the Session layer are categorized into the upper layers dealing with application issues and generally implemented only in software. The Application layer is closest to the end user, and both users and Application layer processes interact with software applications that contain a communications component. The Transport layer, the Network layer, the Data link layer and the Physical layer are categorized into lower layers for handling data transport issues. The Physical layer and the data link layer are implemented in hardware and software. The lowest layer, that is, the Physical layer, is closest to the physical network medium (the network cabling, for example) and is responsible for actually placing information on the medium.

In the present application, a customer user interface layer, namely, Layer 8, is proposed to interact with application layer of the OSI model, so as to allow for customization and ease of use. The software interfaces directly with the graphic application of the application layer to create a much friendlier method to communicate with and control the devices linked to the main server. The customization includes color modifications and icons customizations specifically made for each end user. For example, a picture of a switch ON/OFF symbol can be designed allowing the user to control the ON/OFF status of a light simply by touching the desired symbol. For the dimming control of the light, a scale with various intensity levels may be designed. A numeral value with desired unit such as ° F. or ° C. can be presented for each of the environment temperature control. Accompanied with the numeral temperature value, symbol, text or picture may be designed to indicate the different environment such as pool, Jacuzzi or living room, for example. Controlling or viewing cameras, adjusting volume for audio or video in various rooms and many other controlled devices can all be implemented in the software interface. Alternatively, the software interface can also be standardized. Thereby, all the devices linked to the main server are integrated into one interface. Table 1 provides a brief description of the functions for the seven layers (Layers 1-7) of the OSI model and the customer user interface layer (Layer 8) as provided in this embodiment.

TABLE I

| | |
|---|---|
| Custom User | The user interface allows for customization and ease of use. The software interfaces directly |
| Interface | with the Graphics application of Layer 7 to create a much friendlier method to communicate |
| (Layer 8) | with and control the devices networked using the method of the present invention. Color |
| | modifications and icon customization is preferably provided so that each user will feel that |
| | the interface is specifically made for them. Integrating all devices into one interface is the |
| | key to this solution. |
| Application | This layer supports application and end-user processes. Communication partners are |
| (Layer 7) | identified, quality of service is identified, user authentication and privacy are considered, and |
| | any constraints on data syntax are identified. Everything at this layer is application-specific. |
| | This layer provides application services for file transfers, e-mail, and other network software |
| | services. Telnet and FTP are applications that exist entirely in the application level. Tiered |
| | application architectures are part of this layer. |
| Presentation | This layer provides independence from differences in data representation (e.g., encryption) |
| (Layer 6) | by translating from application to network format, and vice versa. The presentation layer |
| | works to transform data into the form that the application layer can accept. This layer |
| | formats and encrypts data to be sent across a network, providing freedom from compatibility |
| | problems. It is also referred to as the syntax layer. |
| Session | This layer establishes, manages and terminates connections between applications. The |
| (Layer 5) | session layer sets up, coordinates, and terminates conversations, exchanges, and dialogues |
| | between the applications at each end. It deals with session and connection coordination. |
| Transport | This layer provides transparent transfer of data between end systems, or hosts, and is |
| (Layer 4) | responsible for end-to-end error recovery and flow control. It ensures complete data transfer. |
| Network | This layer provides switching and routing technologies, creating logical paths, known as |
| (Layer 3) | virtual circuits, for transmitting data from node to node. Routing and forwarding are |
| | functions of this layer, as well as addressing, internetworking, error handling, congestion |
| | control and packet sequencing. |
| DataLink | At this layer, data packets are encoded and decoded into bits. It furnishes transmission |
| (Layer 2) | protocol knowledge and management and handles errors in the physical layer, flow control |
| | and frame synchronization. The data link layer is divided into two sublayers: The Media |
| | Access Control (MAC) layer and the Logical Link Control (LLC) layer. The MAC sublayer |
| | controls how a computer on the network gains access to the data and permission to transmit |
| | it. The LLC layer controls frame synchronization, flow control and error checking. |
| Physical | This layer conveys the bit stream - electrical impulse, light or radio signal - through the |
| (Layer 1) | network at the electrical and mechanical level. It provides the hardware means of sending |
| | and receiving data on a carrier, including defining cables, cards and physical aspects. Fast |
| | Ethernet, RS232, and ATM are protocols with physical layer components. |

As mentioned above, the software solution as provided can also be integrated with a mobile hardware solution to provide a complete integrated control of a vehicle. The mobile hardware solution includes a mobile personal computer for controlling various electronic devices. Preferably, the mobile personal computer is small and ruggedized enough to withstand the rigors of automobile use including shocks, shacking, vibration and extreme temperature. The mobile hardware solution is designed to fit under the seat, in the glove box, in the console or in the trunk of the vehicle. Preferably, the integrated mobile hardware/software system is able to operate without the need of a standard AM/FM radio or to interface with existing entertainment system.

The supply power of the hardware solution is preferably 12 volts without the need of an inverter, such that the hardware solution can interface directly into a standard 12-volt battery vehicle. The mobile personal computer has Firewire 1394, USB 2.0, serial and parallel connectivity. In one embodiment, the mobile personal computer is equipped with a USB interface operative to connect up to 255 USB devices, multiple serial ports, and up to a 1394 interface operative to connect up to 63 1394 devices. The mobile personal computer may also be interfaced with various electronic devices thus allowing centralized control of a navigation package, a satellite package, a handheld remote control, a pressure sensitive or touch screen, and a cellular modem, for example. Preferably, the navigation package uses a GPS antenna that interfaces with the USB port of the mobile personal computer, the satellite package uses a satellite antenna and receiver to interface with the USB port of the mobile personal computer. The handheld remote control allows the user to change volume, mute, access programs and provides standard mouse control of an electronic system in the vehicle. The pressure sensitive or touch screen can be in any size such as 7″, 10″, 12″ or 15″, for example. Preferably, the pressure sensitive or touch screen has a VGA and USB interface and may be a VGA resolution screen or a standard NTSC/RCA as the customer specifies. The touch screen is the interface to the custom interface system controls. The cellular modem uses a SIM chip has a separate GPRS antenna and connects directly to the serial port of the mobile personal computer. The cellular modem provides the access to the home hardware solution system as described above. Any USB wi-fi interfaces will work as long as the mobile system is inside the “Hot Spots”. An 802.11 interface may be utilized will allow for faster web interfacing but the “Hot Spots” may not be available in all the area where one may travel. Thereby, one may pick up and choose the most reliable and rugged peripherals to create the system solution or electronic integrate system. The system is expandable to use any USB, serial or parallel port interface device. One may also use the standard plug offered on computers.

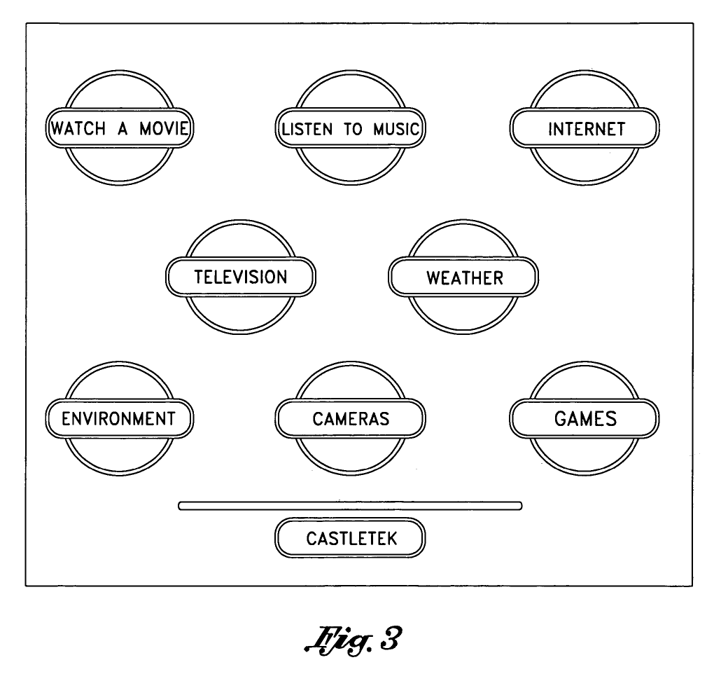

FIG. 2 illustrates an exemplary mobile hardware solution that includes the mobile personal computer 30 in communication with a 7″ VGA touch screen 32 serving as the user interface, a biometric reader 34, a cellular internet modem 36 and a high speed 11 g wireless device 38. The biometric reader 34 allows the user to enable the mobile system when a user-specific fingerprint or other physical characteristic is recognized by the system. The mobile personal computer 30 may also be used to control the functions including MP3 music, DVD movies, GPS navigation, XM radio, wireless internet for home controls, photo browsing, biometrics, faxes, printers, web camera for rear vision or video conferencing, auto diagnostics such as OBDII feedback, and auto crediting in the drive through at restaurants, for example.

As earlier stated, the mobile hardware solution as described above is integrated with a software solution similar to the one used with the home hardware solution. Preferably, the Microsoft Windows XP pro is used as the operating system because the drivers of many existing hardware are already loaded therein. In the software solution, a user interface program which integrates all the hardware devices to be controlled by the mobile personal computer 30 is shown in FIG. 3. As shown, each mobile device may be presented by an icon, a description or a picture. Plain languages or pictures have been used to help the user pick what actions to take for a specific mobile device selected through the user interface.

Preferably, the software controlling the mobile hardware solution is so designed that all the home devices can be controlled by the mobile unit or station such as an automobile. Internet connectivity is preferably used to interface with the home system through a unique IP address. The cellular internet modem 36 or the high speed 11 g wireless device 38 can be used to provide the Internet access in the vehicle, so as to communicate with the home integrated control system as described above. A web user interface is preferably used to allow the user to control the home lights, cameras, HVAC or any other device from the mobile station while the user is miles from home. For example, the touch screen 32 may display a main page allowing the user to select the control access of the mobile devices or the home devices. Alternatively, an individual user interface may be used allowing the user to control the home devices independently and simultaneously with the mobile devices.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A network solution for integrated control of electronic devices between sites, comprising:
a hardware solution, comprising a main server located at a first site and a computer located at a second site, the main server being operative to link with and control various electronic devices at the first site and the computer being operative to link with and control various electronic devices at the second site; and
a software solution loaded in the main server and the computer, the software solution comprising:
a user interface program for interfacing at least one of the main server and the computer with the electronic devices linked therewith according to an input provided by a user; and
an internetworking model interacting with the user interface program to communicate the computer with the main server.

2. The network solution of claim 1, wherein the first site includes a stationary site and the second site includes a mobile site away from the first site.

3. The network solution of claim 2, wherein the computer includes a mobile computer small and ruggedized enough to fit in the mobile site.

4. The network solution of claim 2, wherein the second site includes a vehicle, a watercraft or an aircraft.

5. The network solution of claim 2, wherein the electronic devices linked to and controlled by the computer comprise at least one of a navigation package, a satellite package, a handheld remote control, a pressure sensitive, and a cellular modem.

6. The network solution of claim 2, wherein the hardware solution further comprises a biometric device linked to the computer for identifying the user.

7. The network solution of claim 2, further comprising at least one of a cellular Internet modem and a high speed wireless device to provide a network medium allowing the internetworking model to communicate the computer with the main server.

8. The network solution of claim 7, wherein an 802.11 interface is used for the communication between the computer model and the main server.

9. The network solution of claim 2, wherein the hardware solution further comprises a user interface linked to the computer allowing the user to provide the input to the user interface program.

10. The network solution of claim 9, wherein the user interface includes a touch screen.

11. The network solution of claim 1, wherein the first site and the second site are two different stationary sites.

12. The network solution of claim 1, wherein the electronic devices linked to the main server includes at least one of a temperature control device, a light control device, a camera system, a door locking solution, a drape/shade solution system, at least one personal computer, an oven, and a video/audio device.

13. The network solution of claim 1, wherein the software solution is stored in a memory.

14. The network solution of claim 1, wherein the user interface is customized for each individual user.

15. The network solution of claim 1, wherein the hardware solution further comprises a user interface at each of the first and second sites allowing the user to provide the input to the user interface program at each site.

16. The network solution of claim 15, wherein the user interfaces includes touch screens.

17. The network solution of claim 1, wherein the user interface program includes a customer interface layer and the internetworking model includes Open System Interconnect model having an Application layer, a Presentation layer, a Session layer, a Transport layer, a Network layer, a Data link layer, and a Physical layer.

18. The network solution of claim 17, wherein the customer interface layer interacts directly with the Application layer.

19. The network solution of claim 1, wherein the user interface program is operative to provide a user menu in each of the main server and the computer allowing the user to select access of any of the electronic devices linked therewith, respectively.

20. The network solution of claim 1, wherein the user interface program is operative to provide a user menu in the computer allowing the user to select access of any of the electronic devices linked with the main server at the first site.

21. A software solution for interfacing electronic devices at a plurality of sites through main servers at the respective sites, comprising:
a user interface program allowing a user at a first site to input a task on selected electronic devices at a second site and operative to interface the selected electronic devices with the main server at the second site; and
an internetworking model operative to communicate the main server at the first site with the main server at the second site.

22. The software solution of claim 21, wherein the first site is the same as the second site.

23. The software solution of claim 21, wherein the first site is distant from the second site.

24. The software solution of claim 21, wherein the internetworking model includes the Open System Interconnect model having seven layers and the user interface program includes a customer interface layer interacting with an Application layer of the Open System Interconnect model.

25. The software solution of claim 24, wherein the customer interface layer is operative to integrate all the electronic devices at the same site into the same interface.

26. The software solution of claim 21, wherein the first site includes a car, a boat, a plane or a mobile vehicle.
